(19) United States
(12) Patent Application Publication
(10) Pub. No.: US 2011/0128304 A1
(43) Pub. Date: Jun. 2, 2011

(54) LIGHT EMITTING ELEMENT CIRCUIT AND LIQUID CRYSTAL DISPLAY DEVICE

(75) Inventor: Hironori TAKAOKA, Tokyo (JP)

(73) Assignee: MITSUBISHI ELECTRIC CORPORATION, Chiyoda-ku (JP)

(21) Appl. No.: 12/949,096

(22) Filed: Nov. 18, 2010

(30) Foreign Application Priority Data
Dec. 2, 2009 (JP) 2009-274323

(51) Int. Cl. G09G 3/36; H05B 37/00; H01J 61/52; G09G 5/10

(52) U.S. Cl. 345/690; 315/185 R; 315/113; 345/102

(57) ABSTRACT

A light emitting element circuit according to the present invention includes: a plurality of LED chains connected in parallel to each other, each of the plurality of LED chains including LEDs that are a plurality of light emitting elements connected in series; a transistor that is a reference element connected in series to the LED chain being one of the plurality of LED chains; and transistors that are one or more subordinate elements respectively connected in series to the LED chains among the plurality of LED chains except for the LED chain, a control voltage thereof following a control voltage of the transistor, wherein the transistor takes a voltage of a predetermined node on the LED chain as the control voltage.

### BACKGROUND OF THE INVENTION

1. Field of the Invention

The present invention relates to a light emitting element circuit and a liquid crystal display device and, for example, is preferably used in light emitting element circuits in backlights of liquid crystal display devices used in notebook and desktop personal computers, televisions, monitors and the like, and liquid crystal display devices.

2. Description of the Background Art

In recent years, as a light source of a liquid crystal display device without a self light emitting function, a backlight in which light emitting diodes (hereinafter, referred to as LEDs) are mounted as light emitting elements has been increasing. Some LED drivers for driving the backlight are incorporated in a liquid crystal display device, whereas others are externally mounted.

In an LED backlight, a luminance can be freely set by using a plurality of small LEDs. The use of a plurality of LEDs provides the configuration with several combination patterns depending on the number of series and the number of systems of LEDs. The system used herein refers to a line (LED chain) in which a plurality of LEDs are disposed in series.

The following design guideline is referred to in setting the number of series and the number of systems. First, the LED has large individual variations in forward voltage, and thus the forward currents of respective LEDs vary when constant voltage driving is performed in a series arrangement, which causes variations in luminance. In order to prevent this, it is required to suppress luminance variations by connecting a plurality of LEDs in series to make the forward current uniform.

However, in order to achieve a high luminance by connecting a large number of LEDs in series, an applied voltage becomes large in total, which narrows choices of an IC capable of being driven under this condition. In order to avoid this, consideration should be given not only to a series connection but also to a combination of configurations including a parallel connection. Note that a parallel arrangement of a plurality of systems is advantageous in that even when a certain series circuit fails to turn on due to an abnormality, turn-off of the entire screen including other systems can be avoided.

In this case, the forward currents flowing through respective systems vary more widely as the number of series connections is increased, and hence the forward current flowing through each system needs to be controlled with accuracy.

Therefore, in a conventional LED backlight in which an LED driver is not mounted, anode and cathode terminals are provided for each system so that the forward current of each system can be controlled by an external LED driver. In a case where anode and cathode terminals are provided for each system to be connected to the LED driver, LED drivers equal to terminals in number are required. Also in other model having different inch size and resolution, the same LED driver can be used as long as the configuration of the LED is the same. However, in a case where the number of systems is also increased/decreased when the number of LEDs is increased/decreased in terms of luminance, specifications of an external LED driver need to be changed as well. This leads to a problem that an LED driver has to be changed every time the configuration of a backlight is changed.

In particular, in a backlight that has the same mechanism design, includes an LED unit in which LEDs are mounted on an FPC, and has the structure in which the LED units are interchangeable, specifications of the LED driver need to be changed even in a case where only the LED unit is changed. This causes a problem that a new LED driver is required to be manufactured.

As the methods of solving the above-mentioned problems, Japanese Patent Application Laid-Open Nos. 63-280568 and 2004-253804 disclose light emitting element circuits including current mirror circuits.

### SUMMARY OF THE INVENTION

An object of the present invention is to provide a light emitting element circuit and a liquid crystal display device in which the number of terminals between an LED driver and itself is reduced and applicability of the LED driver is enhanced.

A light emitting element circuit according to the present invention includes a plurality of light emitting element chains connected in parallel to each other, each of the plurality of light emitting element chains including a plurality of light emitting elements connected in series. The light emitting element circuit further includes: a reference element connected in series to a first chain being one of the plurality of light emitting element chains; and one or more subordinate elements respectively connected in series to the light emitting element chains among the plurality of light emitting element chains except for the first chain, a control voltage thereof following a control voltage of the reference element. The reference element takes a voltage of a predetermined node on the first chain as the control voltage.

According to the light emitting element circuit of the present invention, the current between the light emitting element chains, that is, the current of the light emitting element can be controlled without being controlled externally, which makes it possible to improve the applicability to a light emitting element driver.

### BRIEF DESCRIPTION OF THE DRAWINGS

FIG. 1 is a diagram showing a configuration of an LED unit according to a first preferred embodiment;

FIG. 2 is a diagram showing a configuration of an LED unit according to a second preferred embodiment;

FIG. 3 is a diagram showing a configuration of an LED unit according to a third preferred embodiment; and

FIG. 4 is a diagram showing a configuration of a conventional LED unit.

### DESCRIPTION OF THE PREFERRED EMBODIMENTS

### A. First Preferred Embodiment

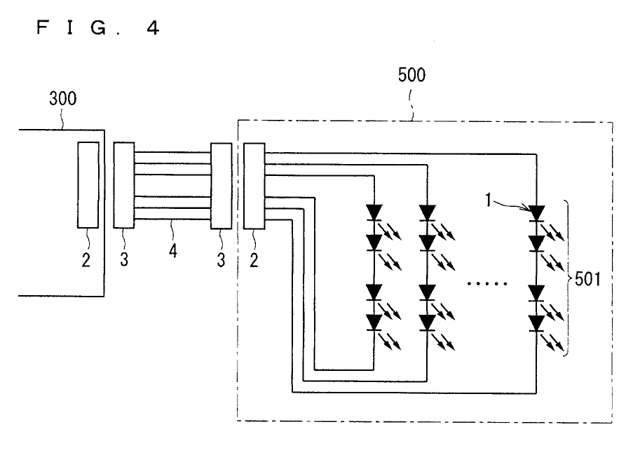

First, the configuration of a conventional LED unit 500 is described with reference to FIG. 4. Conventionally, anode and cathode terminals are provided for each system (LED chain 501) such that a forward current of each system is controlled by an external LED driver 300. For this reason, as many connectors 2 connected to the LED driver 300 and cables 4 extending from a connector housing 3 as the systems are required, and thus the LED driver 300 needs to be changed in accordance with a change of the number of the systems (LED chains 501). Hereinafter, a first preferred embodiment of the present invention for solving the above-mentioned problem is described.

(A-1. Configuration)

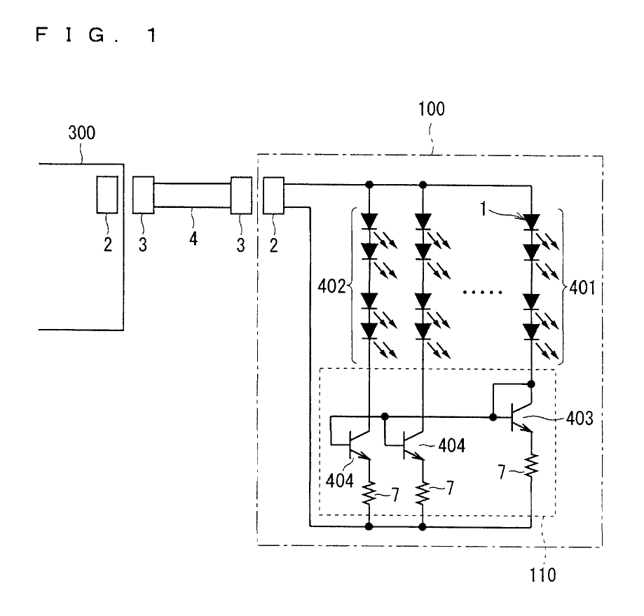

FIG. 1 shows the configuration of a light emitting element circuit according to the first preferred embodiment of the present invention. In an LED unit 100 being a light emitting element circuit mounted in a backlight of a liquid crystal display device, LED chains 401 and 402, which are light emitting element chains including a plurality of LEDs 1 that are light emitting elements connected in series, are connected in parallel to each other, a transistor 403 serving as a reference element is connected in series to the LED chain 401 serving as the first chain, transistors 404 serving as subordinate elements are respectively connected in series to the LED chains 402, and resistors 7 are respectively connected in series to the transistors 403 and 404.

Those components are disposed on an FPC 5, and the configuration including the transistors 403 and 404 and the resistors 7 is a current mirror circuit 110.

A base circuit of the transistor 403 is connected to a collector side of the transistor 403, and the control voltage of the transistor 403 is equal to the voltage of a predetermined node on the LED chain 401. Further, a base circuit of the transistor 404 is connected to the base circuit of the transistor 403, and the control voltage of the transistor 404 follows the control voltage of the transistor 403.

An anode side of the LED chains 401 and 402 connected in parallel has a common wire (anode common wire), and a cathode side thereof ultimately has a common wire (return wire) through the transistors 403 and 404 and the resistors 7 as well. The LED unit 100 is connected to the connector 2 through two wires of the anode common wire and the return wire, and is further connected to an LED driver 300 through the connector housing 3 and a cable 4.

(A-2. Operation)

Next, the operation of the LED unit 100 is described. A voltage is applied to the anode common wire by the external LED driver 300. The voltage is applied to LEDs 1 of the respective systems (LED chains 401 and 402), and then the forward current flows in a forward direction, with the result that the LEDs 1 turn on. The transistors 403 and 404 are controlled by causing the currents to flow through the base circuits of the transistors 403 and 404 based on the forward current of the appropriately provided system (LED chain 401) among the systems. Accordingly, the forward currents flowing through the respective systems (LED chains 401 and 402) have less variations, with the result that variations in luminance of the LEDs 1 are reduced.

In the present invention, the current mirror circuit 110 that does not require voltage control from the outside is provided in the LED unit 100 built in the backlight as described above. Accordingly, it is possible to provide a backlight that suppresses variations of the forward currents flowing through the LEDs 1, that is, has little variations in luminance of the LEDs 1 without increasing types of wires connected to the external LED driver 300 even when the number of the systems (LED chains 401 and 402) is changed in accordance with the specifications. In addition, the types of the wires are uniform, and thus it is possible to use the LED driver 300 that is externally used without changing the specifications thereof.

(A-3. Effects)

According to the first preferred embodiment of the present invention, the light emitting element circuit includes: the LED chains 401 and 402 that are a plurality of light emitting element chains connected in parallel to each other, each of the plurality of LED chains 401 and 402 including the LEDs 1 that are a plurality of light emitting elements connected in series; the transistor 403 that is the reference element connected in series to the LED chain 401 being the first chain that is one of the plurality of LED chains 401 and 402; and the transistors 404 being one or more subordinate elements that are respectively connected in series to the LED chains 402 among the plurality of LED chains 401 and 402 except for the LED chain 401, a control voltage thereof following a control voltage of the reference element, wherein the transistor 403 takes the voltage of a predetermined node on the LED chain 401 as the reference voltage. Accordingly, the current between the LED chains 401 and 402, that is, the current of the LED 1 can be controlled without being controlled externally, which makes it possible to enhance the applicability to the LED driver 300. In addition, the number of externally connected pins is reduced, and thus the cost is expected to be reduced also in selecting connectors.

Further, according to the first preferred embodiment of the present invention, it is possible to control the current of the backlight without being controlled externally by providing the above-mentioned light emitting element circuit as the backlight.

### B. Second Preferred Embodiment

### B-1. Configuration

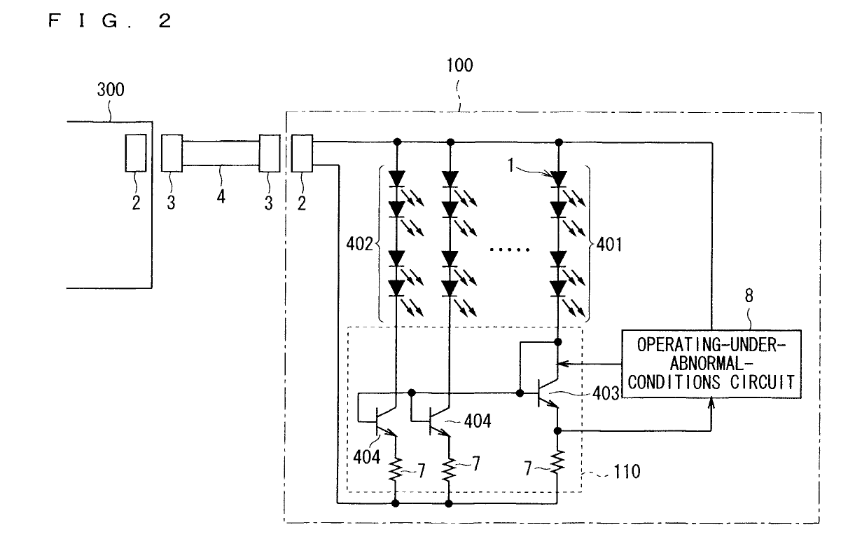

FIG. 2 shows the configuration of a light emitting element circuit according to a second preferred embodiment of the present invention. In addition to the configuration diagram referred in the first preferred embodiment, there is provided an operating-under-abnormal-conditions circuit 8 that operates when the transistor 403 that is the reference element connected to the LED chain 401 being the first chain fails to operate due to an occurrence of a failure or the like. The other configuration is similar to that described in the first preferred embodiment, and thus description thereof is omitted.

In a case where the forward current fails to flow through the LED chain 401 of the system serving as the reference for the current mirror circuit 110 due to a failure of the LED 1 or the like, the entire current mirror circuit 110 fails to operate, and accordingly an operation abnormality occurs. In order to avoid such an occurrence, therefore, the operating-under-abnormal-conditions circuit 8 that operates under abnormal conditions is provided, to thereby prevent all of the LEDs 1 from turning off.

### B-2. Operation

Next, the operation of the LED unit 100 is described. When the LED chain 401 which is the reference system for the current mirror circuit 110 operates, the resistors are applied with a voltage. The voltage is monitored by the operating-under-abnormal-conditions circuit 8. The operating-under-abnormal-conditions circuit 8 does not operate in a case where a voltage is detected. However, when the current fails to flow through the reference system (LED chain 401) due to some malfunctions or the like or when the current becomes equal to or less than a predetermined threshold, the operating-under-abnormal-conditions circuit 8 determines that an abnormality has occurred. In that case, the transistors 403 and 404 are operated after the operating-under-abnormal-conditions circuit 8 outputs predetermined voltage signals to the base circuits of the transistors 403 and 404, to thereby prevent the LEDs 1 from turning off. Note that the power source of the operating-under-abnormal-conditions circuit 8 is not required to receive another voltage or signal from the outside, with the use of the anode common voltage.

### B-3. Effects

According to the second preferred embodiment of the present invention, the light emitting element circuit further includes the operating-under-abnormal-conditions circuit 8 that applies a predetermined voltage to the transistor 403 as the control voltage of the transistor 403 being the reference element in a case where the current flowing through the LED chain 401 being the first chain becomes equal to or smaller than a predetermined threshold. Accordingly, it is possible to prevent the current from failing to flow through the LED chain 401 when an abnormality such as a load open state occurs, to thereby prevent all of the LEDs 1 from turning off.

### C. Third Preferred Embodiment

### C-1. Configuration

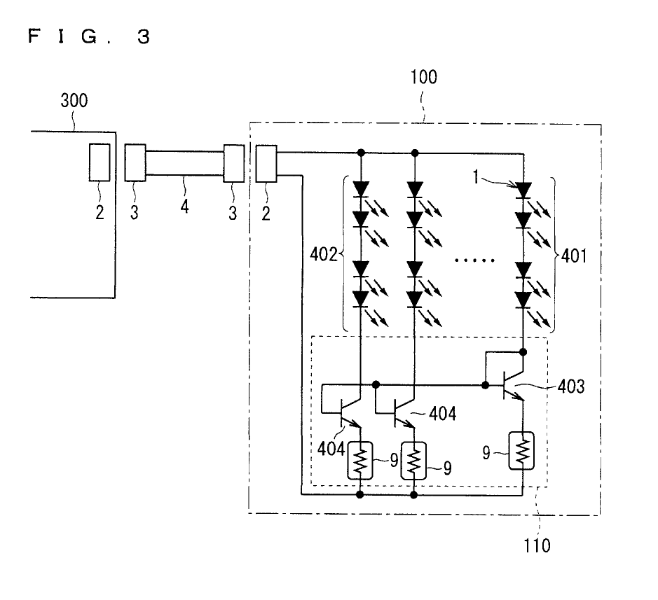

FIG. 3 shows the configuration of a light emitting element circuit according to a third preferred embodiment of the present invention. The light emitting element circuit includes thermistors 9 connected in series to the LED chains 401 and 402, in place of the resistors 7 in the configuration diagram described in the first preferred embodiment. The other configuration is similar to that described in the first preferred embodiment, and thus description thereof is omitted. Alternatively, the light emitting element circuit may further include the thermistors 9 in addition to the resistors 7.

The LED 1 is a semiconductor, and thus its characteristics vary depending on the ambient temperature. The thermistors 9 are respectively connected to an emitter side of the transistors 403 and 404, whereby it is possible to adjust the luminance to a desired one when the forward current commensurate with the ambient temperature is caused to flow even when the ambient temperature changes.

### C-2. Operation

Next, the operation of the LED unit 100 is described. In a case where the characteristics of the LEDs 1 change in accordance with the ambient temperature and the forward currents flowing through the LED chains 401 and 402 change, a resistant value of the thermistor 9 changes so as to cancel a change in forward current. Accordingly, the forward current flowing through the current mirror circuit 110 can have a constant value without being affected by the ambient temperature.

### C-3. Effects

According to the third preferred embodiment of the present invention, the light emitting element circuit further includes a plurality of thermistors 9 respectively connected in series to the LED chains 401 and 402 that are a plurality of light emitting element chains, a resistance value thereof changing so as to cancel a temperature change in value of the current flowing through each of the LED chains 401 and 402. This enables a change in resistance value also in accordance with the temperature change of the LED backlight, which makes it possible to keep the forward current at a constant value.

### D. Other Preferred Embodiment

In the first to third preferred embodiments described above, while the invention is described in detail by taking a light emitting element circuit used in a backlight of a liquid crystal display device as an example, the present invention relates to a drive circuit for driving LEDs, whish is not limited to a backlight drive circuit of a liquid crystal display device. For example, the present invention is applicable as a light emitting element drive circuit built in an LED illumination device that has been recently brought to market in place of an incandescent bulb, where similar effects to those of the above-mentioned preferred embodiments can be obtained.

While the invention has been shown and described in detail, the foregoing description is in all aspects illustrative and not restrictive. It is therefore understood that numerous modifications and variations can be devised without departing from the scope of the invention.

What is claimed is:

1. A light emitting element circuit, comprising:
a plurality of light emitting element chains connected in parallel to each other, each of said plurality of light emitting element chains including a plurality of light emitting elements connected in series;
a reference element connected in series to a first chain being one of said plurality of light emitting element chains; and
one or more subordinate elements respectively connected in series to the light emitting element chains among said plurality of light emitting element chains except for said first chain, a control voltage thereof following a control voltage of said reference element,
wherein said reference element takes a voltage of a predetermined node on said first chain as said control voltage.

2. The light emitting element circuit according to claim 1, further comprising an operating-under-abnormal-conditions circuit applying a predetermined voltage to said reference element as the control voltage of said reference element in a case where a current flowing through said first chain is equal to or smaller than a predetermined threshold.

3. The light emitting element circuit according to claim 1, further comprising a plurality of thermistors respectively connected in series to said plurality of light emitting element chains, a resistance value thereof changing so as to cancel a temperature change in value of a current flowing each of said light emitting element chains.

4. A liquid crystal display device comprising a light emitting element circuit as a backlight,
the light emitting element circuit comprising:
a plurality of light emitting element chains connected in parallel to each other, each of said plurality of light emitting element chains including a plurality of light emitting elements connected in series;
a reference element connected in series to a first chain being one of said plurality of light emitting element chains; and
one or more subordinate elements respectively connected in series to the light emitting element chains except for said first chain among said plurality of light emitting element chains, a control voltage thereof following a control voltage of said reference element.
wherein said reference element takes a voltage of a predetermined node on said first chain as said control voltage.
